(19) United States
(12) Patent Application Publication
(10) Pub. No.: US 2005/0244099 A1
(43) Pub. Date: Nov. 3, 2005

(54) Cantilevered micro-electromechanical switch array

(76) Inventors: Nicholas F. Pasch, Pacifica, CA (US); Glenn C. Sanders, Mountain View, CA (US); Hajime Seki, San Jose, CA (US)

Correspondence Address: CARPENTER & KULAS, LLP, 1900 EMBARCADERO ROAD, SUITE 109, PALO ALTO, CA, 94303, US

(21) Appl. No.: 11/088,390

(22) Filed: Mar. 23, 2005

Related U.S. Application Data
(60) Provisional application No. 60/556,187, filed on Mar. 24, 2004.
(60) Provisional application No. 60/656,855, filed on Feb. 25, 2005.

(51) Int. Cl. G02B 6/26

(52) U.S. Cl. 385/18

(57) ABSTRACT

A flexible micro-electromechanical switch having a cantilevered platform for forming an electrical circuit. A latching mechanism maintains the platform in a biased position after the biasing voltage is removed. The flexible micro-electromechanical switch can be formed into large area arrays and used as the backplane of display devices.

### CROSS-REFERENCES TO RELATED APPLICATIONS

This application claims priority under commonly assigned Provisional Patent Application entitled “On The Use Of Cantilever Beam Structures For The Design And Manufacture Of Switch Arrays And Their Applications To Displays by Nicholas F. Pasch et al, application No. 60/556,187 filed Mar. 24, 2004, the entire disclosure of which is herein incorporated by reference for all purposes and U.S. Provisional Patent Application 60/656,855 filed Feb. 25, 2005 Attorney Docket No. 100115-00400US, the disclosure of which is also herein incorporated by reference for all purposes.

This application is also related to commonly assigned U.S. patent application Ser. No. 10/959,604 filed Oct. 5, 2004, Attorney Docket No. 100115-00100US.

### BACKGROUND OF THE INVENTION

1. Field of the Invention

Embodiments of the present invention relate to micro electromechanical switch devices. More particularly, embodiments of the present invention relate to micro electromechanical layer switches and improvements thereof.

2. Description of the Background Art

Micro Electromechanical systems, or MEMS is a now a well-known art that integrates sub-millimeter scale mechanical and electrical elements on a single silicon device. The microscopic mechanical elements are fabricated using technology similar to those used to manufacture the semiconductor electrical elements. By careful application of lithographic techniques that selectively micromachine portions of a substrate, it is possible to create a MEMS device in a desired configuration. For example, in a MEMS switch, using appropriate fabrication techniques, a suspended structure may be created that may be electrostatically deflected when actuation electrodes are energized. If the structure anchored only at one end with the other end suspended over a contact, it is called a cantilevered platform. When manufacturing a suspended structure, a sacrificial layer is usually removed during manufacture to free up parts of the MEMS mechanical elements.

Cantilever structures are often used as a switching element in many applications. The typical cantilevered platform in the prior art is often based on use of a crystal silicon substrate and depositions of layers of polycrystalline silicon, silicon nitride, and silicon oxide. Unfortunately, the creation of large arrays of switching elements, encompassing area of, for example, a square meter, simply cannot be contemplated when relying on semiconductor fabrication technologies. There is a great need for inexpensive, easy to manufacture large area arrays of switching elements in general and switching elements having cantilevered platforms in particular.

Unfortunately, the prior art practice of applying micromachining technology to the manufacture of cantilevered platforms suffers from an additional drawback. Specifically, it is common for the sacrificial layer to be removed using a wet etch which causes many structures to be inoperable due to stiction. This wet etch procedure has many disadvantages, including high cost, complexity and use of caustic etchants. Because of low manufacturing yields, micromachining technology is particularly ill suited for use when an array of cantilevered switching elements is required. Further, because of the reliance on semiconductor processing technology, even small arrays of cantilevered platforms are expensive and the size of the arrays that can be manufactured is extremely limited.

What is needed is a sub-millimeter scale mechanical and electrical device that not only includes cantilever structures but also is inexpensive to manufacture. In particular, a manufacturing technique that does not require caustic wet ethants would particularly beneficial especially if it were possible to manufacture large arrays of such devices. It is herein taught that it is possible to create a MEMS technology that uses inexpensive materials and processes to create unique products in a size that is uncommon in the traditional MEMS industry.

### SUMMARY OF EMBODIMENTS OF THE INVENTION

Embodiments of the present invention provide MEMS having suspended or structures or cantilevered platforms that are manufactured using low cost techniques on plastic substrates or other flexible materials.

Embodiments of the present invention include a latching switch. Preferably, the switch is a cantilever structure, which is sculpted from a continuous sheet of material. Further, in accordance with the present invention, the sculpted cantilever structure can be manufactured with high yield so it is feasible to form large area arrays of latching switches.

The foregoing and additional features and advantages of this invention will become apparent from the detailed description and review of the associated drawing figures that follow.

### BRIEF DESCRIPTION OF THE DRAWINGS

FIG. 1 is a cross sectional view taken along the line A-A of FIG. 2 and FIG. 3 of an exemplary cell having a cantilevered platform in a micro-electromechanical device in accordance with an embodiment of the present invention.

FIG. 2 is a plan view of a first side of a base layer for the exemplary cell shown in FIG. 1.

FIG. 3 is a plan view of a first side of the cantilevered platform for the exemplary cell shown in FIG. 1.

FIGS. 4A-4C are a plan view of a first side of exemplary cantilevered platform geometries for the exemplary cell shown in FIG. 1.

FIG. 5 is a plan view of a first side of a partial row of the structure layer in cells of an exemplary micro-electromechanical device in accordance with an embodiment of the present invention.

FIG. 6 is a plan view of a second side of the cantilevered platform for the exemplary cell shown in FIG. 1.

FIG. 7 is a block diagram of the drive electronics for a switch array comprising a plurality of the exemplary cells shown in FIG. 1.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Referring now to the drawings more particularly by reference numbers, an exemplary sectional side view of one cell 10 of a micro-electromechanical device in accordance with an embodiment of the present invention is shown in FIG. 1. Arrays of such cells are adapted to many different applications where opposing foils in each cell are selectively controlled to indicate an ON or OFF state. Features of cell 10 are disclosed in the related co-pending application entitled ELECTROMECHANICAL ACTIVE DISPLAY BACKPLANE AND IMPROVEMENTS THEREOF” by Michael Sauvante et al, application Ser. No. 10/959,604 (the '604 application), filed Oct. 5, 2004 the entire disclosure of which is herein incorporated by reference.

Cell 10 includes a cantilevered platform 11 in accordance with an embodiment of the present invention is shown. Cantilevered platform 11 is a projecting structure that is supported at one end by a support structure 12 and is suspended over contacts 13 and 14 at the other end. Support structure 12 and contacts 13 and 14 are affixed to a base layer 15. Although contacts 13 and 14 are illustrated as separate contacts, it should be appreciated that contacts 13 and 14 may be implemented as a single contact if a particular application does not require a latch mechanism for cell 10. It should be further appreciated that the base layer 15 may include conductive traces on both the surface facing the cantilevered platform 11 and on the opposite side. These conductive traces may be used for applications not associated with controlling the switch or detecting whether the cantilevered platform is in contact with the contacts 13 and 14.

Support structure 12 is either printed or deposited to base layer 15 and is not the artifact of a sacrificial layer. Rather, it is preferred that support structure 12 is applied to base layer 14 and then bonded to both base layer 15 and platform 11. The bonding process may include ultrasonic or pressure welding. Support platform 11 is an insulating structure or layer that electrically isolates the cantilever structure from the opposing structure. Depending on the specific implementation of the technology, support structure 12 may be an identifiable layer or a simple electrically insulated space created between base layer 15 and cantilevered platform 11.

The side of platform 11 opposing base layer 15 is patterned with a row trace 16 and a contact 17. Bridge contact 17 is positioned on platform 11 such that when platform 11 deflects toward base layer 15, bridge contact 17 engages contacts 13 and 14. A column driver trace 18 is also affixed to base layer 15 substantially aligned with and opposing row driver trace 16. Under proper bias, an attractive force is created that causes platform 11 to deflect toward base layer 15. Once platform 11 deflects a sufficient amount, bridge contact 17 engages contacts 13 and 14 to form an electrical circuit as illustrated by the dashed outline of the beam 11 and bridge contact 17. In this deflected orientation, cell 10 is in the ON state. In one embodiment, an electrostatic bias generated across traces 16 and 18 causes platform 11 to deflect toward base layer 15. One skilled in the art will appreciate that other attractive mechanisms may be utilized to control deflection of platform 11 such as, by way of example, electromagnetic bias or bimetallic expansion. When the bias is removed, the elastic force of the flexible beam cause beam to return to the OFF state such that bridge contact 17 is no longer in mechanical contact with contacts 13 or 14.

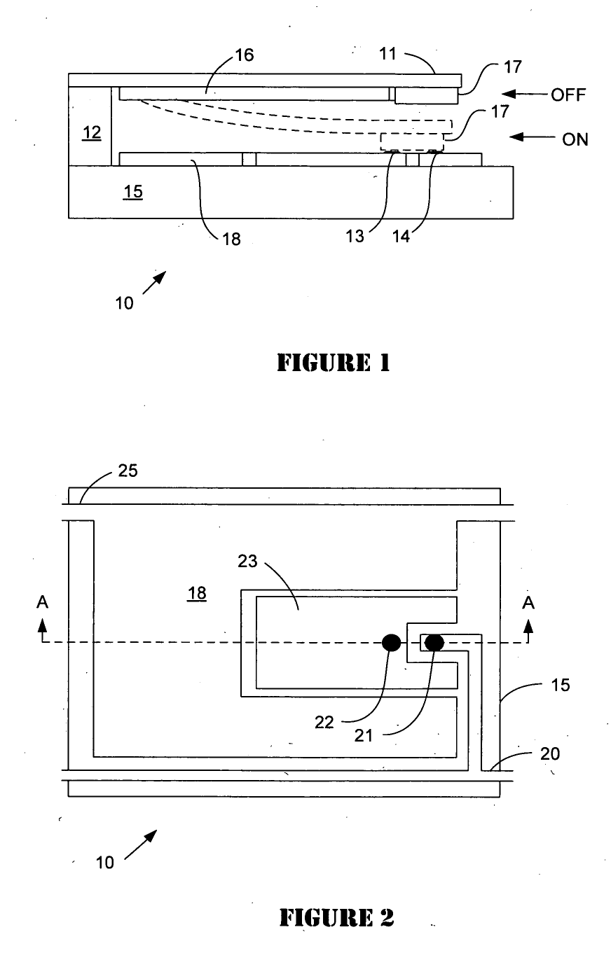

FIG. 2 is a plan view of cell 10 showing one embodiment of base layer 15 that enables platform 11 to be latched after the electrical circuit is formed. The term ‘latched’ means that platform 11 remains in the deflected position even after power is removed from either or both traces 16 or 18. The latching function is enabled by a latch power trace 20 that terminates within cell 10 at a latch power contact 21. Preferably, latch power contact 21 is proximate to latch trace contact 22 such that bridge contact 17 engages both contact 21 and 22 when platform 11 is deflected toward base layer 15. Latch contact trace 22 transfers power to latch trace 23 so that platform 11 is maintained in the deflected position as long as the appropriate bias is applied to latch power trace 20 even if the bias is removed from column driver trace 18. Latch trace 23 comprises a sufficient area of conductive material to maintain the structure in the closed or deflected state after the removal of power from the column electrode. Thus, when latched, the structure will remain in the deflected state until the latch voltage is removed. The latching mechanism 20-23 creates a bi-stable device that minimizes power requirements.

The area dedicated to column driver trace 18 is substantially more than the area used in the latching mechanism. This larger area is necessary because of the need to pull the structure from a quiescent position such as illustrated in FIG. 1 where bridge contact 17 is maintained in a spaced apart relationship to contacts on the base layer to a deflected state where contacts 21 and 22 and bridge contact 17 are in mechanical and electrical engagement. In one embodiment, column driver trace 18 is coupled to adjacent cells by column trace 25 and to drive electronics that generate the appropriate bias to control the operation of the cell 10.

Depending upon the specific application, base layer may include a via structure (not shown) that electrically connects the two sides of base layer 15. The relative sizes and geometries of the various conductive elements are dictated by the particular application and are not further described. The electrodes and contacts comprise conductive films that can be any of a large number of materials including: silver, copper, gold, aluminum, indium titanium oxide (ITO), zinc oxide, silicon and other conductors. Selection of the conductive materials is on the basis of physical, electrical and optical requirements of the particular application. To illustrate, ITO or zinc oxide may be necessary for a liquid crystal display that requires transparency of the backplane structure; while aluminum or copper may function equally well for a reflective electrophoretic display, which does not require transparency of the backplane. It may be desirable to apply an insulation layer over column driver trace 18 to prevent electrical contact with row trace 16.

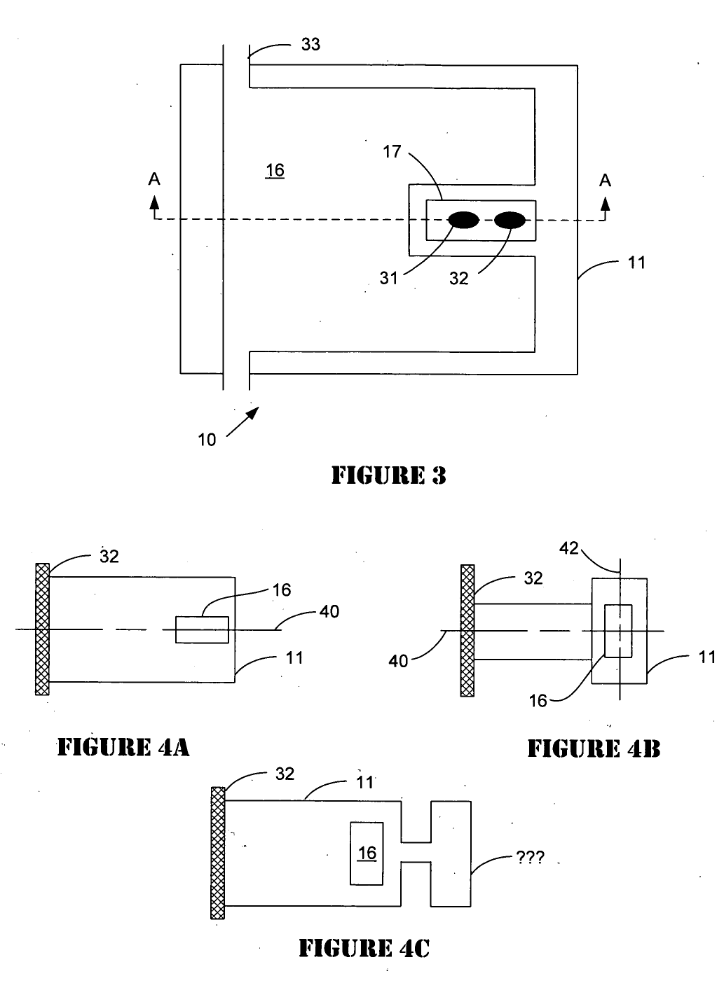

To see the pattern of the conductive elements on the opposing side of platform 11 in plan view, reference is made to FIGS. 3 and 4, which are not shown to scale. FIG. 3 illustrates flexible platform 11 and bridge contact 17 in more detail. Specifically, platform 11 includes conductive electrode 16 that substantially covers the side of platform 11 that faces toward base layer 15. Bridge contact 17 is proximate to the non-supported end of platform 11 and includes a pair of contacts 31 and 32. When platform 11 is deflected toward base layer 15, contact 31 and 32 mechanically engage contacts 21 and 22. With the appropriate steady state bias to either the electrodes 16 and 18 or to electrode 16 and latch power trace 20, platform 11 will maintain mechanical engagement between contacts. Biasing voltage or current, depending on the embodiment, is routed to cell 10 along a row trace 33.

Platform 11 is made from a thin foil of flexible plastic, polymer or other very thin sheet of flexible material. Platform 11 may be created in several ways, but the use of laser abalation of the foil is believed to be the most efficient. In contrast to previous embodiments where membrane deflection predominated the switching function, the cantilever structure resolves several design constraints intrinsic to a membrane switch design such as disclosed in '604 application. Among the constraints that are relaxed is the requirement for use of exceedingly thin flexible foils in the membrane design and the ability to design structural switch arrays that can be substantially flexible, even to the extent that the array can be rolled up and stored until needed or even can function in a partially deformed or twisted condition.

The laser cuts away extra material in the foil to define platform 11 before it is bonded to support structure 12. It is to be understood that use of the term cantilever platform includes complex structures that may combine the functions of cantilever and some form the return spring action associated with stressing the flexible plastic. Thus, it would not be necessary that a cantilever platform be created by completely cutting away all of the material on all three sides of the platform. Further, it may be desirable in some applications to utilize additional layers and provide a mechanism to generate a “disengage bias” to return the cantilevered platform to the open state. One such mechanism is disclosed in U.S. Provisional Patent Application 60/656,855 filed Feb. 25, 2005 Attorney Docket No. 100115-00400US, the disclosure of which is incorporated herein.

Arbitrarily, the cantilevered platform is defined as a rectangle, but it should be appreciated that a large number of geometric configurations for the cell are possible. For example, FIGS. 4A-4C illustrate three representative cantilever structures where bridge contact 17 is positioned proximate to the suspended end of the structure. In FIG. 4A, contacts 31 and 32 are aligned along a longitudinal axis 40 of platform 11 while in FIG. 4B, contacts 31 and 32 are aligned along an axis 42 that is perpendicular to the structures longitudinal axis 40. As used herein, the term ‘cantilever’ includes a plurality of layouts, even with some level of constraint on the free end of the cantilever such as illustrated in FIG. 4C. In FIGS. 4A-4C, the cross shading indicates the area where the cantilevered platform is bonded or laminated to support structure 12.

It will be appreciated that the geometric pattern and the relative area of the electrodes 16 and 18 will be subject to alteration on the basis of the selection of operating voltages, thickness of the base layer 15 and platform 11. The pattern of the electrodes can be manipulated to best use the area available on the basis of material selected for the electrodes, base layer 15 and platform 11 for a particular application. The electrodes and contacts on the cantilevered layer comprise conductive foils that can be any of a large number of materials including: silver, copper, gold, aluminum, indium titanium oxide (ITO), zinc oxide, silicon and other conductors. It may be desirable to apply an insulation layer over row diver trace 16 to prevent electrical contact with column driver trace 18.

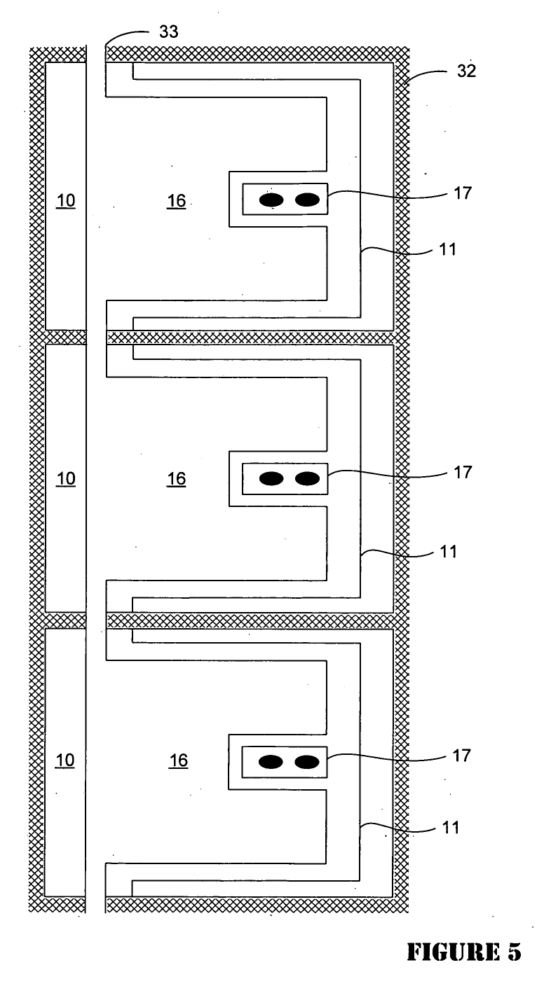

Refer now to FIG. 5, which illustrates a portion of an array 30 having a plurality of adjacent cells 10 coupled by row trace 33. Only a portion of each cell 10 is shown with the structures on base layer 15 not specifically shown or described to avoid obscuring aspects of this embodiment of the present invention. Each cell includes a periphery boundary region that overlays support structure 12, which is shown in dashed outline. It is preferred that base layer 15 and the portions of the structure layer overlaying support structure 12 are bonded together to form the composite structure shown in FIG. 1.

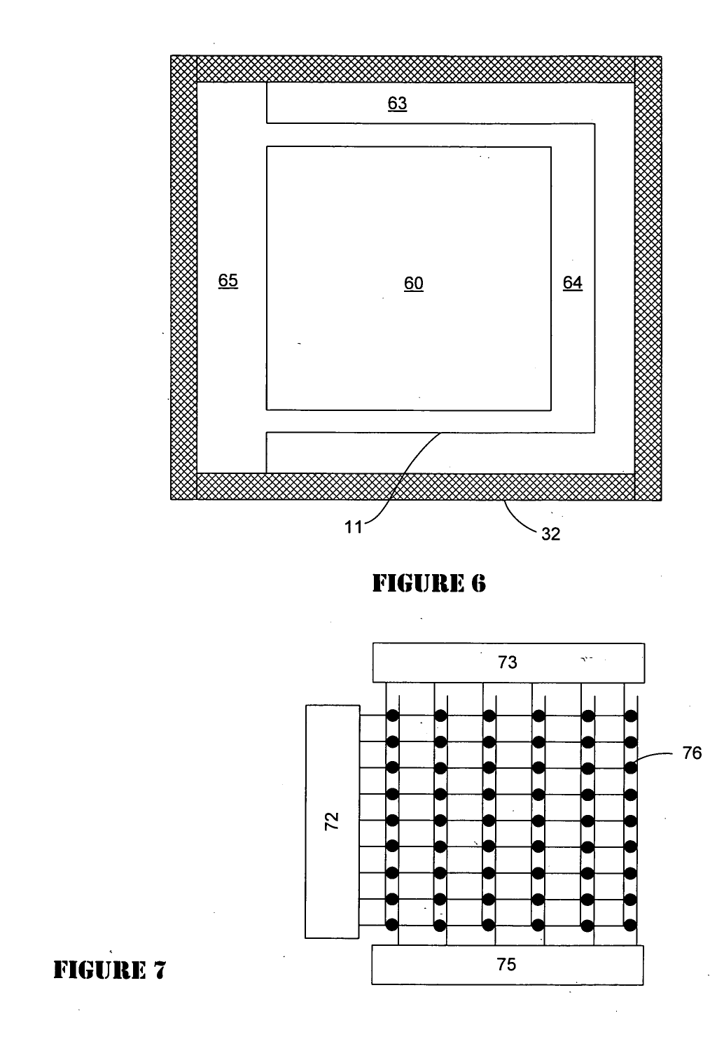

FIG. 6 is a plan view of a second side of the cantilevered platform for the exemplary cell shown in FIG. 1. More specifically, the side of cantilevered platform facing away from base layer 15 is shown having coating of balance metal 60. The purpose of balance metal 60 is to balance the stress associated with the differential temperature coefficient between the conductive traces on one side of the platform and the bulk material of the flexible material of the platform. The balance metal need not be electrically active. Depending upon the expansion coefficient differential between the cantilever layer material and the conductive traces, a coating of balance metal 60 on the opposite side of the cantilevered platform may be necessary to insure the planarity of the cantilever platform. The specific pattern chosen for balance metal 60 will depend on the deviation from planarity caused by the metal traces 16 and 17 on platform 11. At some point, it will be necessary that the balance metal 60 pattern be tuned, a process where the amount of material in the layout of balance metal is reduced until platform planarity is achieved. In other embodiments, the balance metal includes conductive traces that may be coupled to integrated circuits adapted to performing sensing, actuating or other functions.

Along the periphery of cell 10, a portion of cantilever layer material 62 is bonded to the underneath support layer as indicated by the cross shading. A gap 63 between platform 11 and cantilever layer material 62 on either two or three edges frees up platform 11 to move under bias. This gap defines the suspended end 64, which is not supported by support layer and the supported end 65, which is supported by support layer.

Preferably, the patterning of both sides of the cantilever platform will take place before the removal of material to create gap 63. The patterning of the cantilever structure by means of a scanning laser abalation tool is assumed to take place immediately before, as, or after the cantilevered layer material is bonded or laminated to the support structure 12.

As was suggested earlier, the exact dimensions of gap 63 depend on the physical properties of the specific foil being used for cantilever layer material, and the voltages required for operation of the switch.

The combination of the cantilever platform 11, support structure 12, and base layer 15 comprises a switching device that may be combined to allow the creation of a display backplane switch array. Importantly, neither the base layer 15 nor the cantilever layer material 62 must be a rigid material such as semiconductor or glass. Rather, it is preferred and in many applications critical that both base layer 15 and beam layer material 62 are flexible.

Both the voltage potential and the current carrying abilities of the various switch contacts can be different on a single switch element. Thus, the power required to generate sufficient electrostatic bias to attract the cantilevered platform 11 toward base layer 15 can be separate from the power used to latch the switch element. An important advantage with the present invention further enables the use of an additional switch element to conduct charge to an active display element (not shown). The ability to separate the switching process from the latching process and to separate both the switching process and the latching process from the powering active display elements is a powerful enhancement to a display backplane.

The base layer 15 is preferably a polymer foil or flexible sheet-like material and may be substantially less flexible than the platform layer material. In a switch array, all cell elements of a given column, or portions of a column, are electrically connected together. Each column in the array is operated independently from other columns and no column is electrically connected to another column. The relative proportion of the cell or pixel area taken up by the traces is determined by the bias needed for switch operation. The position of the contacts 13 and 14 are desirably located to cause a maximum amount of pressure to be exerted on the contacts when the switch is accessed.

Electrical connection to the switch array can be made by any of a variety of methods and may be dependant on the particular application. The electrical connection includes perimeter contacts, which are a reliable mechanism for connecting a display backplane to drive electronics. A ball grid array is an unusual way to connect a display backplane to an electronic device, but the structure of this switch array would allow such connections. Typically, display drive electronics comprise components that are familiar to the display electronic circuit designer and are not further described in this application. However, it should be noted that the switch array of the present invention utilizes three connections per switching element, rather than the two connections common in conventional active matrix display driver circuits. Accordingly, as shown in FIG. 7, the present invention includes both the conventional row and column drive power sources 70 and 71 and drive circuits 72 and 73 respectively, used in combination with a third coordinated power source 74 and latch drive circuit 75 that drives the latching mechanism. This combination enables, by way of example, the control of a pixel, such as indicated at 76, without periodic refresh.

In operation, the row and column drive electronics 72 and 73 select switch elements of a given row and column of the switch array to be powered by the respective power sources. The latch drive circuit 75 selects the switch elements that will remain latched by the latching power source 74. Since the latching power source 74 is electrically separate from but is coordinated with the row and column drivers 72 and 73 the present invention enables a switch to be maintained in a closed position. The timing and duration of the latching power source is able to effect behavior in the switch array that is ether exactly analogous to that of an active matrix TFT switch array, or it can be made to add aspects of a memory function which are completely novel.

In a first phase of operation with reference to FIGS. 1 and 7, voltages or other bias is applied to row driver trace 16 and to column driver trace 18. The bias creates an electrostatic attraction or other force, such as magnetic, that overcomes the elasticity of the cantilever platform 11. The bias causes the cantilever to bend towards and eventually contact 17 mechanically engages base layer 15.

In one display embodiment, it is desirable that the driver voltages be low enough to prevent unintended activation of the display material. For example, voltage differentials of less than 5-10 V are desirable. It is further desirable that the absolute magnitude of the voltages be less than the active voltage range of the display materials but the magnitude depends on the specific display material chosen.

In this embodiment, row driver circuit 72 operates at ground potential (0V) for a row selected state and at +5V for a row unselected state. The column driver circuit 73 operates at +10V for a column selected state and at 0V for a column unselected state. The array scan takes place by sequentially accessing columns, with all row states activated for each change of column state. In this embodiment, a 10V differential creates a sufficiently large electrostatic attraction to cause the cantilever platform 11 to bend into contact with contacts 13 and 14. Further, a 5V differential is insufficient to cause platform 11 to bend. Engineering simulations of this technology suggest that the use of these voltages is well within the operating range for acceptable materials, manufacturing processes and device size for a large area array for display purposes.

When the bridge contact 17 electrically bridges contact 13 to contact 14, the bias on latch power trace 20 is coupled to the latch trace 23. If sufficiently biased, bridge contact 17 will remain in both electrical and mechanical contact. Due to the limited area associated with the latching mechanism, the latch driver circuit 75 has an output of between 0V or +30V and this voltage is made available to the Latch Power trace after mechanical contact is made. By preference, the latch power trace of a given column is switched to 0V only during the time that that column is being accessed for a state change. As soon as the column has had all of its switches in a stable ON or OFF configuration, the latch power trace has its potential raised to +30V. The latch power potential raises the potential of the latch trace and effects the latching of the switch element. The electrostatic attraction of the latch trace and the row driver trace assures that the switch will maintain itself in an ON state until the latch power trace is returned to 0V.

While it is possible for the latch power to be maintained for long periods of time, such as when the display will not be updated for a protracted period of time, minutes or even hours, it may not always desirable to do so. Advantageously, the latch power may be released at any time. If the latch power is maintained for a short period of time (˜5-50 ms), the switch arrays electrical properties will be indistinguishable from those of conventional thin film transistor active matrix display backplanes. A novel aspect of our backplane array that is not seen in the TFT backplane is that the power to the display elements can be ON continuously and without refresh interruption for as long as required. The ability to latch a display image for protracted periods, without refresh scans is an important powerful and novel aspect of the switch array. As an important example of why this is the case, OLED display material lifetime is well known to suffer from over-driving. Used at a lower average brightness as would be possible with the switch array backplane, the OLED material has a relatively longer lifetime. There is no way with conventional TFT backplanes to allow the OLED material to glow at a lower brightness continuously. The spiking of the brightness with high power spikes, in order to create adequate average brightness is a fault of the conventional TFT backplane.

Thus, the device described herein is suitable for many applications such as display, memory, and cross-point switching applications. The ability of the device to latch electronic information as a part of a switching structure, amplify and change impedance is novel and important. The device, in accordance with the present invention, is well suited for roll to roll manufacture using inexpensive printing equipment and printing techniques.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, further embodiments may include various display architectures, biometric sensors, pressure sensors, temperature sensors, light sensors, chemical sensors, X-ray and other electromagnetic sensors, amplifiers, gate arrays, other logic circuits, printers and memory circuits.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A micro electromechanical device comprising:
a base layer having a conductive trace and at least one contact and a flexible cantilevered platform having a conductive trace and at least one contact aligned with said base layer conductive trace and contact; said base layer and said cantilevered platform maintained in a spaced apart by a spacer layer if no bias is applied to said conductive traces and in mechanical engagement at one portion of said cantilevered platform when a bias is applied to said conductive traces; and
a latching mechanism for maintaining said cantilevered platform in mechanical engagement with said base layer after said bias is removed.

2. The micro electromechanical device of claim 1 wherein said base layer, support layer and cantilevered platform are bonded together to form a composite switch.

3. The micro electromechanical device of claim 2 further comprising a plurality of said composite switches arranged in an array.

4. The micro electromechanical device of claim 1 wherein said cantilevered platform comprises a plastic foil having a suspended portion and a portion attached to said support layer.

5. The micro electromechanical device of claim 1 wherein said cantilevered platform comprises a plastic foil having a suspended portion attached to said support layer.

6. The micro electromechanical device of claim 1 wherein said cantilevered platform further comprises balance metal.

7. The micro electromechanical device of claim 6 wherein said cantilevered platform is cut from a flexible sheet, said flexible sheet selected from a foil of either PET or polymide.

8. The micro electromechanical device of claim 10 wherein said base layer selected from a sheet of PET or polymide.

9. A micro electromechanical device comprising:
a base layer having a conductive trace and at least one contact and a flexible layer having a conductive trace and at least one contact on an opposing side of said flexible layer, said conductive trace and contact aligned with said base layer conductive trace and contact; said base layer and said flexible layer at least partially maintained in a spaced apart by a spacer layer and bonded together to form a composite switch, said flexible layer having a cantilevered platform separated from said flexible layer by a gap such that, said cantilevered platform is maintained in a spaced apart relationship if no bias is applied to said conductive traces and in mechanical engagement at least a portion of said cantilevered platform when a bias is applied to said conductive traces.

10. The micro electromechanical device of claim 9 wherein a plurality of said devices arranged in a plurality of rows and columns.

11. The micro electromechanical device of claim 10 further comprising:
a first driver circuit for controlling a bias across one of said plurality of columns;
a second driver circuit for controlling a bias across each of said plurality of rows to selectively bias said cantilevered platform; and
a third driver circuit for selectively latching said biased platforms in a column after said first driver circuit changes the bias across said one of said plurality of columns, such that said biased platforms remain in mechanical contact with said base layer.

12. The micro electromechanical device of claim 9 wherein said flexible sheet comprises a continuous flexible sheet having said cantilevered platform separated therefrom by laser ablation.

13. The micro electromechanical device of claim 12 wherein said flexible sheet is selected from a foil of PET or polymide.

14. The micro electromechanical device of claim 13 wherein said cantilevered platform further comprises balance metal.

15. A backplane array of switches comprising:
a plurality of composite switches arranged in rows and columns, each of said switches having a base layer and a flexible cantilevered platform at least partially maintained in a spaced apart by a spacer layer; each of said switches having bias means for controlling said cantilevered platform such that, said cantilevered platform is maintained in a spaced apart relationship if no bias is applied to said conductive traces and in mechanical engagement at least a portion of said cantilevered platform when a bias is applied to said conductive traces; each of said switches having at least two contacts for forming an electrical circuit when said cantilevered platform is mechanical engagement;
a first driver circuit for controlling a bias across one of said plurality of columns;
a second driver circuit for controlling a bias across each of said plurality of rows to selectively bias said cantilevered platform;
a third driver circuit for selectively latching said biased platforms in a column after said first driver circuit changes the bias across said one of said plurality of columns, such that said biased platforms remain in mechanical contact with said base layer; and
means for biasing a display medium.

16. The backplane array of switches of claim 15 further comprising a front plane having OLED display material.

17. The backplane array of switches of claim 16 further comprising a latching mechanism for displaying an image without refresh scans.

18. The backplane array of switches of claim 15 further comprising a front plane having OLED display material biased at a constant voltage.

19. The backplane array of switches of claim 15 further comprising a front plane having OLED display material biased at continuous intermediate level of brightness.

20. The backplane array of switches of claim 15 further comprising a large area display having a front plane comprising an OLED display material.

21. The backplane array of switches of claim 15 wherein said large area display comprises an area of at least one square meter.

22. The backplane array of switches of claim 15 wherein said cantilevered platform further comprises balance metal.

23. The backplane array of switches of claim 15 wherein said cantilevered platform is cut from a flexible sheet, said flexible sheet selected from a foil of either PET or polymide.
